(19) United States
(12) Patent Application Publication
(10) Pub. No.: US 2014/0282493 A1
(43) Pub. Date: Sep. 18, 2014

(54) SYSTEM FOR REPLICATING APPS FROM AN EXISTING DEVICE TO A NEW DEVICE

(71) Applicant: Quixey, Inc, Mountain View, CA (US)

(72) Inventors: Eric Glover, Sunnuvale, CA (US); Marshall Quander, Mountain View, CA (US)

(21) Appl. No.: 13/839,068

(22) Filed: Mar. 15, 2013

(51) Int. Cl. G06F 17/30; G06F 9/445

(52) U.S. Cl. CPC G06F 17/30864; G06F 8/61
USPC 717/176; 707/706

(57) ABSTRACT

A method to recreate an application (“app”) experience on a first device on a second device, includes identifying one or more existing apps on the first device; generating a query for one or more apps matching the existing apps; sending the query to an application search engine through an application programming interface (API); searching an application search engine for one or more matching applications; and returning a set of matching apps in response to the query using the API.

### BACKGROUND

This application relates to recreating applications between two platforms or devices.

Smart phones and tablet computers have rapidly gained popularity as people use them to entertain, conduct business, communicate with customers and increase efficiencies. The growth of smart phones and tablet computers has resulted in an enormous market for applications, also referred to herein as apps, running on cell phones, smart phones, and other computing devices. A typical usage model for these applications includes users going to a central location where all the apps are located/advertised, selecting the appropriate app, and trying the app for a fixed duration of time. If the users like the app, users may download and pay for the full version of the app.

As of 2013, mobile operating systems such as iOS® by Apple Inc. of Cupertino, Calif. and ANDROID® by Google Inc. of Mountain View, Calif., account for the majority of apps. Recently, new smartphone operating systems (OSs) have emerged to compete with iOS and Android. However, due to the iOS and Android “app-losion”, the incumbents continue to roll with downloads and users become invested in existing platforms that would make it difficult to walk away from them. This bias toward the top two market leaders in mobile OSs makes it difficult for users to try new innovations in mobile OSs or even new versions of the same OS.

### SUMMARY

In one aspect, a method to recreate an application (“app”) experience existing on a first device for a second device includes identifying one or more existing apps on the first device; generating a query for one or more apps matching the existing apps; sending the query to an application search engine through an application programming interface (API); searching an application search engine for one or more matching applications; and returning a set of matching apps in response to the query using the API.

Advantages of the system may include one or more of the following. The system identifies functionally similar or identical apps across platforms, and similar apps on the same platform. By integrating the technology into a product, a partner can help an end user recreate a smartphone experience on their new device similar to his or her old device by providing the user with functionally similar or identical apps on the new phone. The system enables users in a new platform to quickly reestablish their favorite apps. This is done with no app discovery (from a users' perspective). For example, in app discovery, users need to be aware of a particular app to find the app to try it out. For example, when switching to a new OS platform or even new versions of the same OS, users can simply reselect their apps without having to re-search for a given app by various search criteria in the hopes of finding one that meets their needs. The system enhances user experience as potentially viable apps are no longer overlooked by users because of the difficulties associated with searching by the use of search terms.

### BRIEF DESCRIPTION OF THE DRAWINGS

Having thus described the invention in general terms, reference will now be made to the accompanying drawings, which are not necessarily drawn to scale, and wherein:

FIG. 1A-1D show exemplary systems and processes to replicate exact or similar application(s) from one mobile device to another.

FIG. 1E-1F show another embodiment of processes to replicate exact or similar application(s) from one mobile device to another.

FIG. 2A shows one exemplary system for similar application.

FIG. 2B shows an exemplary app-search engine.

FIG. 2C shows an exemplary app data mining system.

FIG. 3 shows an exemplary system with data from multiple partners' feeds to enhance the centralized search index.

FIG. 4 shows an example where the centralized system learns from data logs.

FIG. 5 shows an exemplary system where a partner uses analytics data for comparing their activities to the rest of the relevant world.

### DESCRIPTION

FIG. 1A shows an exemplary system to recreate an application (“app”) experience existing on a first device 1 for a second device 2. The system includes an app detector 100 that identifies one or more existing apps on the first device and then generates a query to the app detector 100 for one or more apps matching the existing apps. The app detector 100 sends parameters in the query to a partner 102. The partner 102 in turn applies one or more filters to the query and sends the query to an application matcher 104 through an application programming interface (API). The app matcher 104 searches an application search engine for one or more matching applications; and returns a set of matching apps in response to the query using the API. The partner 102 receives the results and sends the proposed replacement apps for mobile device 2 to select and install. The system identifies functionally similar or identical apps across platforms, and similar apps on the same platform. By integrating the technology into a product, a partner can help an end user recreate a smartphone experience on their new device similar to his or her old device by providing the user with functionally similar or identical apps on the new phone. The system enables users in a new platform to quickly reestablish their favorite apps. This is done with no app discovery (from a users' perspective). For example, in app discovery, users need to be aware of a particular app to find the app to try it out. For example, when switching to a new OS platform or even new versions of the same OS, users can simply reselect their apps without having to re-search for a given app by various search criteria in the hopes of finding one that meets their needs. The system enhances user experience as potentially viable apps are no longer overlooked by users because of the difficulties associated with searching by the use of search terms.

FIG. 1B shows an exemplary process for automatically suggesting apps for users moving from one mobile device to another. In this process, a user has a number of apps on his or her mobile device with a different OS or OS version, and desires to populate a new device with the same or similar apps. The user requests similar app assistance (10).

The software scans existing apps on the original mobile device (12). The result of the scan is a set of app IDs. App IDs, or application identifications, are unique names or number strings associated with mobile smart phone applications. The application ID will be the string of numbers listed after a series of names. For example, in the link “phobos.examplelinkname.1234567” the number string “1234567” represents the unique app ID. In Android, developers reference and use the numerical app ID, and the app ID to consumers is simply the actual name of the application.

The list of existing apps is sent to a partner (14) which can be a new OS developer, for example. The partner uses an application program interface (API) to call a functional search system to locate identical apps or similar apps on the new OS (16). In one embodiment, the search is Functional Search which allows users to search for apps by describing what they want to do and returns apps that can complete their task. Users can search natural language queries in addition to app names and keywords. The system can search all types of apps, from mobile, tablet, desktop apps to web apps, plug-ins, and online platforms such as Salesforce, Facebook and Flickr. The system offers partners the ability to customize the search to its strategic needs. The search technology can be applied to custom app ecosystems. For example, if the partner is running a private app store with its own set of apps, the search can be easily customized to search only the partner's apps. The search can be filtered with standard or custom facets based on ratings, categories, price, published date, or properties as specified. The search results can be returned in customized formats, such as JSON, for example.

The functional search system locates best matches for the existing apps and replies to the API call with a set of similar apps and their app IDs back to the partner (18). The partner in turn formats the results and displays the result to the user for his or her selection (20). The user then can replicate as much of the apps on the existing mobile device on the new mobile device (22).

FIG. 1C shows an exemplary embodiment of the app matcher 104. In this system, an API builder 120 receives a query with one or more app IDs, Target device or destination, Source device, and one or more filters. The API builder 120 provides the app ID, source device and destination device as well as a limit on the search result to a similarity engine 130. This is done by consulting app IDs in a canonical app meta database, which is described in more details below. The resulting app IDs are used by the similarity engine 130 which locates exact or similar apps for each app ID, up to the specified limit of matching results, and provide app IDs for the destination device to the API builder 120. The similarity engine 130 also receives the app IDs, Target device or destination, Source device, and one or more filters. The similarity engine includes an app ID matcher 143, a title matcher 134 and an offline similarity table 136, as described in more details below.

FIG. 1D shows an exemplary process for similarity matching. The process receives a request to match a source application or app on a first device or platform to exact or similar applications on a second platform (150). The process first checks if a matching source application identifier (app ID) exists in an application database (152). If not, the process returns “no match” (154). Alternatively, the process maps the app ID to a canonical app ID (156). The process checks if a match is found for the destination device/platform (158). If so, the process determines whether the app is likely to be a game app by checking if a “gaminess” of the app ID is within a predetermined threshold (160). If so, the process determines if the app ID satisfies a predetermined importance threshold, which is a measure relating to how many people have used the app and thus reduces the ability of users to trick the system with pretenses on the app. Thus, if the app ID matches the destination device app ID, and if the app ID is of the same game or non-game classification, and it has sufficient users or otherwise deemed important, then the app is added to the output list (164). From 164, if the limit determined by the part is not satisfied, the process continues to select the next matching app ID for processing. Otherwise, if the limit has been reached, the process returns the list of matching apps (199).

In 158, if there is no exact app ID match on the destination platform or device, the process checks for a title match between a source canonical app and a database (170). If so, the process checks for available app ID for the destination platform (172). If so, the process determines whether the app is likely to be a game app by checking if a “gaminess” of the app ID is within a predetermined threshold (174). If so, the process checks if the app ID satisfies a predetermined importance threshold. Thus, if the title of the app matches the title of a destination device app ID, and if the app ID is of the same game or non-game type, and the app has sufficient users or otherwise deemed important (176), then the app is added to the output list (178). Thus, if there is no exact app ID match, but an exact title match for the destination platform, the process checks if the candidate apps satisfy certain quality filters and if so includes the apps with exact title match as part of the output list. From 179, if the limit determined by the part is not satisfied, the process continues to select the next matching app ID for processing. Otherwise, if the limit has been reached, the process returns the list of matching apps (199).

Next, if there is no exact title match in 170, the process checks if there are similar titles or “weak” title match between the source canonical app and the database (180). If so, the process checks if the app ID satisfies a predetermined importance threshold (182). Thus, if the title of the app weakly matches the title of a destination device app ID, and if the app ID is of the same game or non-game type (184), and the app has sufficient users or otherwise deemed important (186), then the app is added to the output list (188). From 189, if the limit determined by the part is not satisfied, the process continues to select the next matching app ID for processing. Otherwise, if the limit has been reached, the process returns the list of matching apps (199).

From 180, if nothing matches, the process cross-checks for canonical app similarity score database with the source canonical app (190). The process then returns all apps whose similarity score exceeds a predetermined threshold (192) and filters the resulting apps (194). The process then ranks similarity apps by their scores (196), and outputs top canonical apps until the limit specified by the partner is reached (198).

FIG. 1E shows an exemplary process for the functional search system operation 18. In this process, the API call is received with a list of app IDs that need to be matched for a new device (30). The process determines whether exact matches for the app IDs already exist and the app IDs and target app IDs are already known to the system (32). If so, the process returns the matching app for the target platform (38). In one embodiment, the process uses a look-up table with the app ID for the current platform and locates an entry for the target platform and returns the corresponding entry as the result. In another embodiment, the process checks if the input app ID is a game app or not, and uses this info to verify that the matching app is also of the same type (game or no game). The app matching can be done using app function and/or name normalization for transforming the app ID into a single canonical form that represents various versions of the same app. In another embodiment, the app ID or application resource identifier may include an identifier of a native application and the one or more parameters used to access the state of the application. In some implementations, each app ID or application resource identifier may further include the type of operating system for which the identified native application is configured. Additionally or alternatively, each application resource identifier may include a version of the native application. For example, if the native application is offered in a “free version” and a “pay version,” one of the application resource identifiers 16 may identify the free version of the native application and another of the application resource identifiers may identify the pay version of the native application.

From 32, if there is no exact match in the system's database, the process performs an exact title match (ETM) by searching for the app's exact name to see if an app with exact name match occurs for the target platform (34) and if so returns the matching app (38). In one embodiment, the process checks if the input app ID is a game app or not, and uses this info to verify that the matching app is also of the same type (game or no game).

From 34, if there is not exact title match, the process searches for a weak title match by locating similar apps whose name resembles or is similar to the name of the app ID (36) and returns with the apps with the closest matching titles as the result (38).

From 36, if there is no exact or similar title match at all, the process searches for similar apps using a similarity matrix 40. With games database 39A and non-games database 39B, the process checks if the input app ID is a game app or not, and uses this information to look up the similarity matrix (40).

The similarity matrix is a matrix of scores which express the similarity between two data points. One approach has been to empirically generate the similarity matrices using computer or human curated analysis of all known apps. Similarity matrices are strongly related to their counterparts, distance matrices and substitution matrices. Higher scores are given to more-similar characters, and lower or negative scores for dissimilar characters. A matrix M that exhibits the following five characteristics is a similarity matrix.

Squaredness=M must have the same number of rows and columns.

Non-Negativity=all elements of M must be real, non-negative numbers.

Boundedness=all elements of M must adopt values between 0 and 1.

Reflexivity=all diagonal elements of M (i.e. from left to bottom) must be filled with 1.

Symmetry=all ij elements must be identical to all ji elements.

In one embodiment, latent semantic indexing (LSI) is used with the similarity matrix as an indexing and retrieval method. LSI uses a mathematical technique called singular value decomposition (SVD) to identify patterns in the relationships between the terms and concepts contained in an unstructured collection of text. LSI is based on the principle that words that are used in the same contexts tend to have similar meanings A key feature of LSI is its ability to extract the conceptual content of a body of text by establishing associations between those terms that occur in similar contexts. The method, also called latent semantic analysis (LSA), uncovers the underlying latent semantic structure in the usage of words in a body of text and how it can be used to extract the meaning of the text in response to user queries, commonly referred to as concept searches. Queries, or concept searches, against a set of documents that have undergone LSI will return results that are conceptually similar in meaning to the search criteria even if the results don't share a specific word or words with the search criteria.

Turning now to FIG. 1F, one exemplary similarity app determination process 40 is shown. First, the process applies a game classifier to the app ID to see if the app is a game type or not (42). If the score is below a threshold n in 44, the process infers that the app is a game. The process then takes an LSI score among the game apps and checks for apps that meets a predetermined LSI score, with sufficient text similarity and sufficient text (46). The process checks to see if any apps satisfy the filter (48). If so, the process suggests these apps as matching apps (70). Otherwise the process lowers the coefficients for text similarity and sufficiency, and decreases the LSI threshold (60) and checks again for qualifying apps (62). If so, the process suggests these apps as matching apps (70) and exits. Otherwise the process indicates that there is no matching app (72) and exits.

From 44, if the score exceeds n, the process takes the LSI from non-game apps, and checks for apps satisfying a predetermined LSI, text similarity and sufficiency (66). The process then locates qualifying apps (68). If matching apps exist, the process suggests these apps as matching apps (70) and exits. Otherwise the process process indicates that there is no matching app (72) and exits.

In one embodiment, the determination of similar apps can be done using off-line processing, or it can be procured using human review. In another embodiment, automated machine learning system can be done. The system uses a number of techniques to determine what is likely to be a “good match” for an app. In one embodiment, a Machine Learned Relevance score (or just any relevance score on a fixed range, say 0 to 1) is performed, and the results from the consideration set over a pre-defined threshold, say 0.8, can be used. The selection of the threshold can be done by tuning the system to find which cutoff value works the best.

In another embodiment using a Machine Learned Ranker—which learns from a human assigned target (for example a scale from 1-5)—that a target is mapped from 0-1 in 0.25 increments, so a 5=1, 4=0.75, 3=0.5, 2=0.25, 1=0. In this example, a returned score of 0.75 would mean the learner thinks a human would judge it as a “4”—so that is also a reasonable cutoff. In practice with a good learner, good data and good targets, the system will have actual meaning to the numerical score returned.

In another embodiment, the system keeps the top N highest scoring apps (i.e. the first 20 shown results) as long as they are over some lower cut-off. Alternate methods could include keeping the best with a pre-clustering and a limit on how many from each cluster, or using all the clusters, or having this process done separately for each cluster.

The minimum requirement is for one pass scoring to be done, and more passes are “optional”. The system can also solve multiple centroids i.e. do multiple alignments—i.e. query such as “subway” would discover results which are about the angry bird as a distinct group from those which are about bird watching and distinct from bad results which happen to “mention” birds, for example a result that finds “movie the Bird” when the user is looking for the game Angry Birds.

After this, the best apps in the ranking are selected to do the next iteration, but changing the probability values, and then the same for the followings until it is considered that the result list is “likely good”.

The selection of the best apps can be done in many ways, and one method uses a cutoff on the adjusted relevance score—and all results being considered over that cutoff are kept. Other methods can include simply keeping the top n (say 30) if there are at least some minimum number of results over a minimum threshold.

Further, a query log as discussed below may also be used in order to predict the context of the query that has been posed by the user. This helps in improving the retrieval of results that may be relevant to the user corresponding to the query submitted.

In one embodiment that searches for applications, responsive to receiving a search query, an application search module identifies one or more matching applications based on the search indexes. In one embodiment, the one or more applications may be identified based on how closely the functionalities of the applications match the functionalities expressed (implicitly or explicitly) in the received search query. Following identification of the applications, a results list referencing the applications may be provided to the user. In some implementations, the application search module employs a suitable machine learned model to facilitate the automatic identification of the functional capabilities of the applications.

Canonical applications may be located in any suitable manner. In one embodiment, the canonical applications are located by comparing data (e.g., identification data such as publisher names, titles, etc.) for each application edition identified in the received data against data for a collection of known canonical applications. In one embodiment, if an incoming edition is matched to a canonical application in the collection, the system determines that the incoming edition is an edition of the canonical application. Thus, the incoming edition is grouped with the other editions of the canonical application. In contrast, if a match is not identified for the incoming edition, the system determines that the incoming edition is associated with an unknown canonical application. In one embodiment, the system adds or merges a new canonical application based on the incoming edition to the collection of applications. The system further groups the incoming edition under the newly added canonical application. To determine whether an incoming edition is associated with an unknown canonical application, various similarity and clustering mechanisms may be employed.

In one embodiment, the system additionally extracts attributes for each canonical application identified from the received data. The extracted attributes for each application may together form a representation of the individual application. In one aspect, the attributes for each application are extracted according to an application-search specific schema. The application-search specific schema may serve as a model for defining the representations of each individual application. More specifically, the application-search specific schema may specify the attributes that are to be extracted for each application. The application-search specific schema may further indicate the manner in which the extracted attributes are to be organized. For example, the application-search specific schema may indicate that certain attributes be grouped under the general canonical application whereas other attributes may be organized as part of each edition of the canonical application. Illustratively, an attribute for image conversion functionality may be organized under the general canonical application whereas a platform attribute may be organized as part of each edition of the canonical application.

In one embodiment, each extracted attribute may be associated with a particular type. Examples of attributes types may include functional type attributes (e.g., attributes related to application battery usage, bandwidth usage, general operational functionality, etc.). Other examples of attributes types include identification type attributes (e.g., attributes related to an application's title, publisher information, etc.), sentiment type attributes (e.g., attributes related to an application's popularity), and/or the like.

In one embodiment, attributes may additionally be textual or non-textual. More specifically, attributes that are textual may be directly obtained from text in the received data. Attributes that are non-textual may be those attributes that are not directly taken from the text of the received data. Rather, the attributes may be extracted, derived, or inferred based in part on an analysis of the received data.

Extraction of the attributes from the received data can proceed in any suitable manner. In one embodiment, the system extracts attributes for an application directly from the text of the received data. For example, the system may extract an attribute from text of the received data, where the received data explicitly indicates that the text includes an attribute for a particular application.

In one embodiment, the system may extract attributes by making inferences related to the text of a document or based on any fields in the document from the received data. It is noted that, a document can be any object that includes content related to an application, such as user reviews, description information, developer information, blog content, etc. For example, based on an analysis of the language of an application developer's website, the system may determine that the website is written in the Portuguese language and that the IP address for the website specifies a location of Brazil. As such, the system may extract an attribute for the application indicating that it is primarily directed at a Brazilian Portuguese-speaking audience. As another example, based on analysis of terms in a review of an application, the system may determine that the review is directed to a sports fan audience. As such, the system may extract an attribute for the application indicating that the application is related to sports.

In one embodiment, the system extracts an attribute for an application by combining data from different sources. Illustratively, the system may extract a quality score attribute for an application by normalizing and combining star ratings for the application received from various data sources.

In one embodiment, the system may extract an attribute by analyzing different combinations of the received data and/or other data. As an example, the data from an application developer may indicate that an application is appropriate for children under the age of thirteen. Reviews associated with the application may also indicate the same. As a result, the data from the application developer may be reinforced by the reviews such that the system may extract an attribute indicating that the application is appropriate for children under the age of thirteen.

FIG. 2A shows one exemplary system 200 for automatically suggesting apps for users moving from one mobile device to another. The system communicates with partners 202-204 using search application program interface (API). In this example, a customer requests recommendations for apps that are similar to the customer's existing app portfolio to a partner 202, causing the partner 202 to send a “similar app” search request through a search API 204 to the search engine 200. Search engine 200 in turn provides partner-specific ranking results 206 to the search API 204 as a response, and the search API 204 in turn returns the search response to partner 202 who in turn shows the list of similar apps to the customer for download and installation as desired. The “similar app” request can be sent for a switch from one OS build to another OS build, or from one OS platform to a competing OS platform, among others.

For example, a customer wishing to switch from a first mobile device 213A to a second mobile device 213B running a different OS can request a recommendation for similar apps from his or her existing device. In response, a partner 212 sends a “similar app” search request through search API 214 to the search engine 200. Search engine 200 in turn provides partner-specific ranking results 216 to a search API 214 as a response, and the search API 214 in turn returns the search response to the partner 212. Each partner 202 and 212 can render the returned response it its own way to enhance partner services to their customers.

The similar app search engine 200 has a database with a large and high-quality set of candidate apps covering multiple platforms. Each app has sufficient collected data associated with it to provide for meaningful retrieval and ranking (i.e. more than just titles and descriptions). In one embodiment, an app-specific schema and ontology to effectively capture both textual and non-textual features, and to incorporate data from multiple sources of different types. The system has a high performance search framework, designed to be fast for large data. A strong focus is provided on effectively processing the user's query, given the goal of functional app search. The system has a large up-to-date repository with many unique apps, many with more than one edition. Multiple versions or editions of the same app are unified into a single app using a domain-specific schema. To improve recall and relevance, the system combines data from multiple sources. These sources include several that are not created or directly influenced by app developers. This substantially improves the ability to handle functional searches.

The application search process enables partners (organizations) to easily integrate similar application suggestions provided by a central third party into their own systems. Each partner is able to send requests through a standard API and receive a standard response—which the partner can then format as desired. Each partner can also specify to use any subset of applications based on constraints in the API, as well as optionally provide a separate feed of specific applications and constrain their search to their selected feed. The search engine can utilize partner-specific learning to influence ranking based on the individual partner's user activities and preferences. In one embodiment, the system can monetize the search process through inclusion of advertisements in the form of sponsored applications included in the result feed, allowing for this service to be provided at no cost to the customer and a profit center for the search provider (and possibly customer).

The search APIs 204 and 214 have the same format. There is only one API so the actual API protocol is the same for both 204 and 214—but the engine behaves differently based on the particular partner sending the request.

The system provides data and communication flow through the similar app-search system 200 from the partner search request to result response and partner rendering. Unlike existing search systems, this approach provides substantially more control for partners—both through customizations of the API and through an optional feed. Additionally, the system describes a beneficial approach to search through specification of partner-specific learning, a feature not normally present in centralized search systems, or not possible if each partner has non-intersecting data using conventional search systems.

FIG. 2B shows an exemplary similar app search engine 200. In this system, relevance/ranking is handled through a machine learner, and substantial domain-specific feature engineering—all tied back to a schema. System features are designed specifically for functional type queries, leveraging both textual and non-textual information, with the goal of best matching the user's intent.

A custom built index and engine are designed for maximum relevance at large scale, as shown in FIG. 2B. A query Q is provided to query processing unit 230 which communicates with data store 232 whose indices and feature data are generated by an offline processing and data building unit 234. The data store 232 generates a pre-consideration set 236, whose output is processed by a set reducer 238 into a working set 240. The result is provided to a result set processor 242 that generates an initial result set 244 that is provided to a scoring system 246 to generate scored results 248.

The entry point (Q), is a representation of the query and some additional input context such as platform constraint. Given the input, the system constructs a set of queries to our data storage indexes. It also constructs the set of query-features Fq, (a simple example of a query feature is the number of words in the query.). The functional search determines a good set of potentially relevant results, i.e. high recall. This can be difficult since the words in the query might not exactly match the text associated with the app. Once a large set of potentially relevant results (P) is found, they need to be pared down to a size reasonable for processing. The set reduction must be efficient and make decisions based only on a small subset of features, otherwise the computational cost per search becomes too high. Imagine a query like “games”: there are approximately 150,000 apps in one embodiment that contain either the word “game” or “games”, as well as potentially thousands of other apps which are in the category of “games” and need to be considered, even though they do not actually mention the word “game”. Of the 150,000 apps mentioning games, many are not relevant for the query. For example, a review might say “Skype is so much fun, I have stopped playing games so I can have more time to chat with my friends”. While Skype is a very high-quality and popular app, this review containing the term “game” is not relevant. This decision should be made as early and cheaply as possible, to allow time for ranking the best games.

The data store returns a set of apps (possible results) and associated result features Fr. The result features are properties of the apps and not the query. They include the apps' platforms, number of words in the title, star-rating, any type of authority score, machine-learned quality score, and others. These features are used to pare down the set P to the consideration or working set.

Once a reasonably sized consideration set is determined, Result Set Processing determines the remaining features. This includes calculation the query-result features Fqr, which are a function of both Q and static properties of each result. Each result has corresponding information within the search index, from which other features can be looked up or calculated. Query result features are calculated information such as distances between query terms in the title, or other properties not included in the original Fr.

Pre-generated result features take up index space, so choosing whether to store a feature in the index, compute it at search time, or find it by lookup within another index or external data store presents a timeless engineering tradeoff. Generating query-result features can be very expensive, and depending on a feature's complexity, it could form the majority of the total search runtime cost. A feature dependent on string intersections or positions of terms might require scanning blocks of memory or disk, adding many microseconds per considered result. If you were to spend ten microseconds generating feature values for each of 100,000 games, the total CPU time would be one second, which is too long for a real-time search—and that is just the time to generate the features required for scoring.

Given each app's complete set of features as well as the query-specific features Fq, the scoring system calculates an overall score for each app in the consideration set. Using models learned offline, the set of all features is then processed to produce scores. Once all the features are determined using a non-linear combination of features, the system capable of capturing much more subtle variations than linear models. The scored results can then be post-processed as required to provide the final result-list presentation, and pulling in display-related metadata such as result image, or description text, some of which may depend on the query.

The system uniquely collect, organize and process multiple sources of data about apps. The system combines data from many sources, such as reviews and catalogs. Unfortunately, apps don't have unique identifiers. Unlike with URLs, where, for instance, ten different pages linking to cnn.com are all referring the same entity, ten app-data sources referring to an app named “flashlight” or an app named “mortgage calculator” are not always referring to the same app. Matching different data sources to specific apps within the schema is non-trivial and essential to do well. Improper matching has a negative effect on relevance, while, on the other hand, a failure to include the right data can result in a reduction of recall.

Referring now to FIG. 2C, an exemplary mining system to collect information on app data is shown. In this system, an off-line processing engine 235 collects data from app developers 240 or through developer home pages 242. The engine 235 also captures app information from a plurality of app stores 244. Other sources of data such as app review sites 249, app catalogs 246 and blogs 248. The result is an online index 237.

In addition to the need to quickly retrieve and score possibly relevant results, the indexes, offline features and source data must be generated and kept up to date. This is made more difficult by erratic change in the universe of apps. New apps appear and old ones disappear, new app versions come out, people change their opinions. The latest and greatest VOIP client is better than the previous leader, reviews come out panning some app, a security concern makes another app undesirable.

FIG. 3 shows how the system uses data from multiple partners' feeds to enhance the centralized search index. In FIG. 3, Partner 1 104 provides data feed to a feed processor P1. Similarly, Partner 2 108 provides data feed to a feed processor P2 and Partner 3 114 provides data feed to a feed processor P3. The sets 102, 106 and 112 could overlap—but the results allowed for each of these partners is defined by the source feeds P1, P2 and P3.

The system performs data acquisition by finding editions of apps in app repositories, catalogs and on the web at large (especially when indexing web apps), and obtaining structured and unstructured data from sources describing application editions. Data merging is then done where matching data gathered from distinct sources as belonging to the same app, and doing so in a language and platform-independent way. The system ensures that the data is fresh and updated. The system rapidly builds appropriate and efficient indexes to facilitate search. By effectively incorporating user activity data, the system is resistant to deception and gaming by app stakeholders.

FIG. 4 shows how the system learns from the logs—both for each individual partner and overall to improve the relevance for all partners—through a “local model” and a “global model.” In FIG. 4 a global logs 510 receives log data from Partner 1 log 504, Partner 2 log 508 and general user log 514. The global logs 510 provide data to a global model generator 524, Partner 1 model generator 526 and a Partner 2 model generator 528. Partner 1 ranker 536 receives inputs from the global model generator 524 and the Partner 1 model generator 526, while Partner 2 ranker 538 receives inputs from the global model generator 524 and the Partner 2 model generator 528. Finally, the generic ranker 534 receives input from the global model generator 524, but no partner model data. The global logs go through a global model learner which outputs the global model using the global model generator 524. The global logs also goes through a “partner X model learner” for each partner which outputs “partner X model” for each of model generators 526-528.

In one embodiment, the engine 200 uses a domain-specific schema and ontology that is strongly tied to the offline data-collection system, relevance and learning system. Available data is increased by treating an app as a collection of distinct editions that spans a variety of platforms and data-sources. This enhances the important features of an app, giving the system substantial advantages over searches that only access one source of data, such as single-source app-stores/sources. The approach is advantageous even when the search is constrained to just a single platform. In the same way that Google leverages the power of the web graph to make judgments about an individual web page, the instant system leverages multiple sources of data to improve its understanding about each app. This multitude of data sources provides superior knowledge over what could be gleaned from seeing only a biased corner of the app ecosystem.

In one implementation, the system uses machine learning for generation of meta-features such as text-relevance and search quality. Machine learning can also be used for overall scoring. The machine learning process begins with a set of “training data”, consisting of a matrix of IDs, features and target scores. For example, the system might be training a text-relevance meta-feature to follow a range of 1 to 5 (the same as a human might input) and the features might be “number of query terms in title”, “number of important query-terms”, “average query-term frequency”, “number of reviews containing all query terms”, “BM-25 reviews”, “BM-25 description”, “number of query terms”, “first position of match”, “title coverage”, among others. The target could be the human judgment (1,2,3,4 or 5). Targets are typically on a scale from 0 to 1 (0 sometimes being best), although most learners are agnostic to affine transformations. This type of learning is called ‘supervised learning’.

Once the learner is given an input vector of features with targets, the learner produces a model. Typically learners try to minimize some error function of the training set and candidate model (e.g. mean squared error). It is also common to perform some type of cross-validation to improve the accuracy of the model. The generated model can then be applied to an input consisting of the same class of features, and it will output a predicted score—in this case, a value predicting the human judgment. Overall accuracy is a function of the size, distribution and accuracy of the training set data, the quality (representativeness/accuracy) of the features, and the representative capacity of the learner. This ignores the tuning of parameters required for many types of learners, features, or training data.

The world of apps is highly dynamic—every day new apps appear (and disappear), the users' tastes change, and new sources of data appear. Spam and active deception are rapidly becoming an even larger problem. Likewise, new platforms are appearing, and app technology changes rapidly—today Android, iPhone and Facebook apps dominate, but the situation is fluid. The system flexibly stays abreast of the changes to ensure that the features, schema and machine learned models all reflect the changing world, as does the collected data.

FIG. 5 shows a system where a partner can have analytics data comparing their activities to that of the world. In this system, the global logs 510 provides data to a global log processor 624 and to Partner 1 log processor 626 and Partner 2 log processor 628. The partners can receive analytics information from Analytics API 636-638 which receive data from Partner 1 log processor 626 and Partner 2 log processor 628, respectively. Additionally, the partners can receive global analytics information from the global log processor 624. A global analytics API 634 is also available for access by all partners.

All Partners communicate using the same API—the difference is the input to the API is the “appropriate logs.” Thus, Partner 1 communicates over Analytics API, and Partner 2 communicates over the same Analytics API. Each API has different inputs that receive outputs from a back-end process which feeds different data to each partner—but the API is the same.

The partner specific ranking with comparison to other partners' data is returned. The global query provides aggregated data in a personally non-identifiable format that cannot be used to reveal other partner's confidential information.

The system also uses feature engineering. Relevance or usefulness is a function of much more than simply the keywords present in the title or description, or present in a pre-defined list of categories. This requires an architecture and offline database and online index schema which is easily adaptable to rapid feature development.

The search system offers a per-partner personalization, all-partner learning, partner-control over the set of applications searched by their API requests, has coverage of many different platforms—designed to easily add more/new platforms. Also unique is the process of how the API is utilized by the partners, the way the leverages all the different data sources to improve searches for all partners, both in terms of coverage and relevance. Specifically, each partner (sometimes referred to as customer) has the ability to provide their own feed of apps, and access to a personalized partner dashboard—specific to the app-search system. The dashboards are unique—the options available to the partners can vary. Likewise, the business model/process includes advertising through sponsored Applications added to the result feed, as opposed to relying on downloading of applications for revenue. The system does not prevent customers from having their own users download applications which result in revenue for them—i.e. the customer can decide which links the users go to when applications are shown as results—allowing them substantial control and unique integration capabilities not possible from a typical centralized ASP/API-based search system. Lastly, the simultaneous use of global and per-partner data allows for improved relevance, improved targeting, and improved functionality for the per-partner dashboard. The ability to compare their own user's actions vs the “world” can be used for multiple purposes—and is not possibly by a solution which is either one-size-fits-all (i.e. all partners are seen as equal in the system) or by locally installed systems or by third-party solutions which isolate each customer.

Per-partner learning is done for advertisements. The system supports an advertising model—pays customers—sponsored application ads—based on showing application or other results as sponsored, as opposed to pay-per-download (current model).

In one embodiment, the API gets search results and also fetches “ad-results”—the ad-results can be adjusted by an ad-selector which takes as input both “global model” and “partner-specific model”—which are generated from the logs. In this manner, not only does the search get personalized, so does the ads. So the same query might result in different advertisements based on the usage of other users by the same partner. For example—partner 1 is mostly people who play games, while partner 2 is mostly businesses people—so the query “instant messenger” might show an advertisement for an app to help “chat While playing games” to partner 1, but partner 2 might be shown “corporate messenger”. A similar approach can be used for sponsored applications into the result feed.

Using both local and global activity data in the partner-dashboard (should be separate claim—improvement over Google's Analytics)—comparing Apples to apples—i.e. how popular are your games versus all games—or single applications relative popularity, among others.

The configuration of the components, the communication flow between the parties and the specific aspects of the central search system allow the above features to be implemented. The system improves application search by providing both technical and business advantages and unique capabilities to both partners who use the centralized search system, as well as the owner of the centralized search system. The system offers unique capabilities for partners to have personalized views of the world of apps, while benefiting from the centralized and large scale centralized search provider.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

As one of ordinary skill in the art will appreciate, the example process and system described herein can be modified. For example, certain steps can be omitted, certain steps can be carried out concurrently, and other steps can be added. Although particular embodiments of the invention have been described in detail, it is understood that the invention is not limited correspondingly in scope, but includes all changes, modifications and equivalents coming within the spirit and terms of the claims appended hereto.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

What is claimed is:

1. A method to recreate an application (“app”) experience existing on a first device for a second device, comprising:
identifying one or more existing apps on the first device;
generating a query for one or more apps matching the existing apps;
sending the query to an application search engine through an application programming interface (API);
searching an application search engine for one or more matching applications; and
returning a set of matching apps in response to the query using the API.

2. The method of claim 1, comprising mirroring the apps on the first device to the second device.

3. The method of claim 1, comprising selecting an app with a matching name as a response to the query.

4. The method of claim 1, comprising selecting a similar app as a response to the query.

5. The method of claim 1, comprising selecting an app with an approximately matching name as a response to the query.

6. The method of claim 1, comprising returning the set of matching apps to a partner.

7. The method of claim 6, wherein the partner generates a user interface for the user to install the set of matching apps.

8. The method of claim 1, comprising determining if an existing app has an entry matching the existing app with a matching app for the second device, wherein the second device is on a different operating system or operating system version of the first device.

9. The method of claim 1, comprising wherein each app is represented as a set or list of terms or token sequences representative of one or more functional attributes of the app.

10. The method of claim 9, comprising capturing external data from blogs, forums, application stores, social networking sites, and tweets, and extracting terms and concepts from external data to represent the one or more functional attributes of the app.

11. The method of claim 1, wherein the second device is on a different operating system or operating system version of the first device.

12. The method of claim 1, wherein the application search engine has one or more partner specific rankings, comprising matching apps based on one or more criteria from uses of one or more partners.

13. The method of claim 12, comprising returning different sets or different ranked results for the search query for each partner.

14. The method of claim 12, comprising displaying local and global trends for a partner.

15. The method of claim 12, comprising displaying both local and global activity data in a partner-dashboard.

16. The method of claim 12, comprising providing a “personalized feed” of application search result for a partner.

17. The method of claim 12, comprising applying global usage data to improve relevance for all partners.

18. The method of claim 12, comprising leveraging individual partner usage data to improve search ranking for the individual partner.

19. The method of claim 12, comprising providing results from one customer's feed to other customers.

20. The method of claim 1, comprising collecting data on a plurality of applications available on a plurality of platforms.

21. A method to installing applications, comprising:
receiving a search query for applications on a first mobile device;
communicating with the application search engine through an application programming interface (API);
searching an application search engine to locate search result for one or more matching applications, wherein the matching apps include one or more of: exact matching apps, exact title match apps, approximate title match apps, and similar apps; and
installing the one or more matching applications on a second mobile device.

22. A computing device, comprising:
a network interface adapted to enable bidirectional communication to and from the computing device;
a display configured to display content;
a memory configured to store apps that are executable by the computing device; and an app management component configured to: detect exact or similar apps installed on a remote computing device; generate an app guide that is displayable on the display, the app guide listing exact or similar apps on the remote computing device to a user of the computing device for installation.
